(19) United States
(12) Patent Application Publication
(10) Pub. No.: US 2010/0111028 A1
(43) Pub. Date: May 6, 2010

(54) DOWNLINK RECEPTION INDICATION METHOD IN PACKET BASED MOBILE COMMUNICATION SYSTEM

(76) Inventors: Jae-Heung KIM, Daejon (KR); Kyoung-Seok Lee, Daejon (KR); Jung-Im Kim, Daejon (KR); Byung-Han Ryu, Daejon (KR); Seung-Chan Bang, Daejon (KR)

Correspondence Address: LAHIVE & COCKFIELD, LLP;FLOOR 30, SUITE 3000, ONE POST OFFICE SQUARE, BOSTON, MA, 02109, US

(21) Appl. No.: 12/638,385

(22) Filed: Dec. 15, 2009

Related U.S. Application Data
(63) Continuation of application No. PCT/KR2008/003370, filed on Jun. 16, 2008.

(30) Foreign Application Priority Data
Jun. 15, 2007 (KR) 10-2007-0058985

(51) Int. Cl. H04W 72/04

(52) U.S. Cl. 370/329

(57) ABSTRACT

Provided is a method for indicating a mobile station maintaining radio resource control (RRC) connection but not maintaining uplink physical layer synchronization to receive downlink signals when packet data to be transmitted to the mobile station are generated to thereby make the mobile station start uplink signal transmission. The method includes: (a) allocating a random access preamble index and generating a downlink signal reception indication message including the allocated random access preamble index in a base station; (b) transmitting the generated downlink signal reception indication message to the mobile station; (c) forming a response message to random access, when a preamble signal designated by the random access preamble index is transmitted from the mobile station in response to the downlink signal reception indication message; and (d) transmitting the response message to random access to the mobile station to thereby control uplink physical layer synchronization.

### RELATED APPLICATIONS

This application is a continuation of PCT application No. PCT/KR2008/003370, filed on Jun. 16, 2008, which claims priority to, and the benefit of, Korean patent application No. 10-2007-0058985, filed on Jun. 15, 2007. The content of the aforementioned applications is incorporated herein by reference.

### BACKGROUND

The present invention relates to a technology for indicating a mobile station to receive downlink signals in a packet-based mobile communication system; and, more particularly, to a downlink signal reception indicating method that can indicate a mobile station operating according to a discontinuous reception (DRX) period to save power consumption during Radio Resource Control (RRC) connection state to receive downlink signals and adjust effectively uplink synchronization in a packet-based mobile communication system, when the mobile station is not maintaining uplink synchronization.

In a conventional mobile communication system, a base station allocates a transport channel, which is a fixed channel, and a physical channel only to idle-state mobile stations in Radio Resource Control (RRC) disconnection between the base station and mobile stations, and transmits paging information to them. Paging is executed to the conventional idle-state mobile stations as follows.

Mobile stations belong to at least any one paging group among paging groups defined in conformity to an effective paging procedure in a system. A base station informs mobile stations of a corresponding group that there is a paging message transmitted through a paging channel through a paging indication channel (PICH), which is a physical layer. The mobile stations monitor the paging indication channel at every predetermined period, such as a discontinuous reception (DRX) period. When the mobile stations find PICH information corresponding to the group they belong to, they retrieve paging channel (PCH) information transmitted through a secondary Common Control Physical Channel (S-CCPCH) and demodulate the PCH information having an identifier. Herein, the identifier of a mobile station includes an International Mobile Subscriber Identifier (IMSI), a Temporary Mobile Subscriber Identifier (TMSI), and a Universal Mobile Telecommunications System (UMTS) Terrestrial Radio Access Network—Radio Network Temporary Identifier (U-RNTI). After demodulating the paging information transmitted to them, the mobile stations perform subsequent process.

Meanwhile, there may be a plurality of S-CCPCHs through which paging channel information to secure paging capability according to the radio environment and capacity of a base station. When the S-CCPCHs are allocated to a base station with cell-specific parameters, the allocated S-CCPCHs are used fixedly. There is an inefficient aspect in the radio resource allocating method assuming the maximal capacity and fixedly operating the paging channels and the S-CCPCHs, but the method has been needed to stably operate a circuit-based mobile communication system.

However, 3^{rd} General Partnership Project (3GPP) is currently working on standardizing packet-based Long Term Evolution (LTE) systems, which are packet-based mobile communication systems, to improve the disadvantages of conventional circuit switching-based Wideband Code Division Multiple Access (WCDMA) system. LTE systems are packet-based mobile communication systems for realizing packet-based communication at as high data transmission rate as 100 Mbps, and they are expected to be commercialized by the time of around 2010. The packet-based mobile communication systems currently under discussion in the LTE are of wireless transmission method using Frequency Division Duplex (FDD). The packet-based mobile communication systems utilize Orthogonal Frequency Division Multiple Access (OFDMA) method for downlink data transmission and Single Carrier Frequency Division Multiple Access (SC-FDMA) for uplink data transmission.

Generally, the OFDMA method uses radio resources of a two-dimensional (2D) structure that is identified by frequency and time. According to the OFDMA method, radio resources formed of time and frequency are allocated to and transmitted through downlink and uplink physical channels. The radio resources are radio resource blocks divided according to Transmission Time Interval (TTI), which is a transmission period, and sub-carrier groups. Radio frames that constitute the radio resources include subframe (or TTI) of 1 millisecond. To take an example, a radio frame of 10 milliseconds includes 10 subframes.

Meanwhile, in the packet-based mobile communication systems discussed in the LTE, not only idle-state mobile stations without Radio Resource Connection (RRC) connection, which are simply referred to as RRC_IDLE-state mobile stations, but also those receiving packet services while maintaining RRC connection are supposed to perform power-saving operation according to burst characteristics of packet data in order to reduce power consumption in the mobile stations according to a discontinuous reception (DRX) period when there is no packet data exchanged between the base station and mobile stations. In other words, mobile stations maintaining RRC connection to provide a packet service between the base station and the mobile stations, which will be referred to as RRC_CONNECTED-state mobile stations, can perform power-saving operation at DRX periods under the control of the base station. Therefore, although the packet-based mobile communication system for providing a packet service having burst characteristics can efficiently and variably use radio resources, it requires for a method and process for informing RRC_CONNECTED-state mobile stations, which are monitoring downlink channels at the DRX period, of the beginning of downlink data transmission.

If the base station does not transmit a Medium Access Control (MAC) message, which informs generation of downlink packet data, to a certain mobile station and the base station transmits radio resource scheduling information and packet data through downlink without executing a random access (RA) procedure for acquiring uplink physical layer synchronization in the mobile station, the mobile station cannot transmit Hybrid Automatic Repeat reQuest (HARQ) response information for the downlink packet through uplink even though it has received packets. In other words, mobile stations without uplink physical layer synchronization may be able to receive scheduling information for downlink radio resources and packet data blocks transmitted as the scheduled radio resources, but they cannot transmit acknowledgement (ACK) or non-ACK (NACK) response information through the uplink, which is needed to transmit HARQ. If a mobile station transmits ACK or NACK response information, which is needed to transmit HARQ, without the achievement of uplink physical layer synchronization through an acquisition procedure, the base station does not only normally receive the ACK or NACK response information transmitted from the mobile station but also the response information works as an interference signal to signals transmitted from other mobile stations to the base station. Therefore, mobile stations without uplink synchronization need a method for controlling uplink synchronization according to a random access procedure initiated by the mobile station itself or a downlink signal reception indication from the base station and beginning uplink data transmission after acquiring the uplink synchronization.

When mobile stations are maintaining RRC connection with a base station for a packet service but not maintaining uplink physical layer synchronization and the mobile stations should be made to resume a downlink packet service, it is required to develop a method for acquiring uplink physical layer synchronization as well as informing the mobile stations of the presence of information to be transmitted thereto.

### SUMMARY

An embodiment of the present invention is directed to providing a downlink signal reception indicating method that can indicate a mobile station operating according to a discontinuous reception (DRX) period to save power consumption during Radio Resource Control (RRC) connection state to receive downlink signals and effectively control uplink synchronization in a packet-based mobile communication system, when the mobile station is not maintaining uplink synchronization.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

In accordance with an aspect of the present invention, there is provided a method for indicating a mobile station maintaining radio resource control (RRC) connection but not maintaining uplink physical layer synchronization to receive downlink signals when packet data to be transmitted to the mobile station are generated to thereby make the mobile station start uplink signal transmission, the method which includes: (a) allocating a random access preamble index and generating a downlink signal reception indication message including the allocated random access preamble index in a base station; (b) transmitting the generated downlink signal reception indication message to the mobile station; (c) forming a response message to random access, when a preamble signal designated by the random access preamble index is transmitted from the mobile station in response to the downlink signal reception indication message; and (d) transmitting the response message to random access to the mobile station to thereby control uplink physical layer synchronization.

In accordance with another aspect of the present invention, there is provided a method for indicating a mobile station maintaining RRC connection but not maintaining uplink physical layer synchronization to receive downlink signals when packet data to be transmitted to the mobile station are generated, the method which includes: (a) receiving a paging message, which is downlink signal reception indication message, including a random access preamble index allocated by a base station in a mobile station operating at a discontinuous reception period to save power consumption; (b) performing random access by using a preamble designated by the random access preamble index included in the downlink signal reception indication message; (c) receiving response information from the base station in response to the random access operation; and (d) controlling uplink physical layer synchronization based on the received response information.

In accordance with another aspect of the present invention, there is provided a method for indicating a mobile station maintaining RRC connection but not maintaining uplink physical layer synchronization to receive downlink signals when packet data to be transmitted to the mobile station are generated, the method which includes: (a) generating a downlink signal reception indication message including a random access preamble index for non-contention-based random access allocated by a base station and transmitting the generated downlink signal reception indication message to the mobile station so that the base station indicates the mobile station of presence of packet data to be transmitted thereto as well as indicating the mobile station to control uplink synchronization; and (b) when a preamble signal designated by the random access preamble index is transmitted from the mobile station in response to the downlink signal reception indication message, transmitting response message to random access to the mobile station so that the mobile station establishes uplink physical layer synchronization.

In accordance with another aspect of the present invention, there is provided a method for indicating a mobile station maintaining RRC connection but not maintaining uplink physical layer synchronization to receive downlink signals when packet data to be transmitted to the mobile station are generated, the method which includes: (a) receiving a downlink signal reception indication message including a random access preamble index for a non-contention-based random access allocated by a base station in order to indicate the mobile station of presence of packet data to be transmitted to the mobile station as well as indicating the mobile station to establish uplink synchronization; (b) transmitting a preamble designated by the random access preamble index included in the received downlink signal reception indication message, which is a paging message; and (c) when the response information to random access is transmitted from the base station, establishing uplink physical layer synchronization by using the received response information.

### BRIEF DESCRIPTION OF THE DRAWINGS

FIG. 1 exemplarily illustrates how response information to random access is transmitted in accordance with an embodiment of the present invention.

FIG. 2 is a flowchart describing a process of transmitting a downlink signal reception indication message to a mobile station with Radio Resource Control (RRC) connection but without uplink synchronization and transmitting downlink packet data in accordance with an embodiment of the present invention.

FIG. 3 is a flowchart describing a process of performing Medium Access Control (MAC) paging onto a mobile station with RRC connection but without uplink synchronization and transmitting downlink packet data in accordance with another embodiment of the present invention.

### DETAILED DESCRIPTION

The advantages, features and aspects of the invention will become apparent from the following description of the embodiments with reference to the accompanying drawings, which is set forth hereinafter. When it is considered that detailed description on a related art may obscure a point of the present invention, the description will not be provided. Hereinafter, specific embodiments of the present invention will be described in detail by referring to the accompanying drawings.

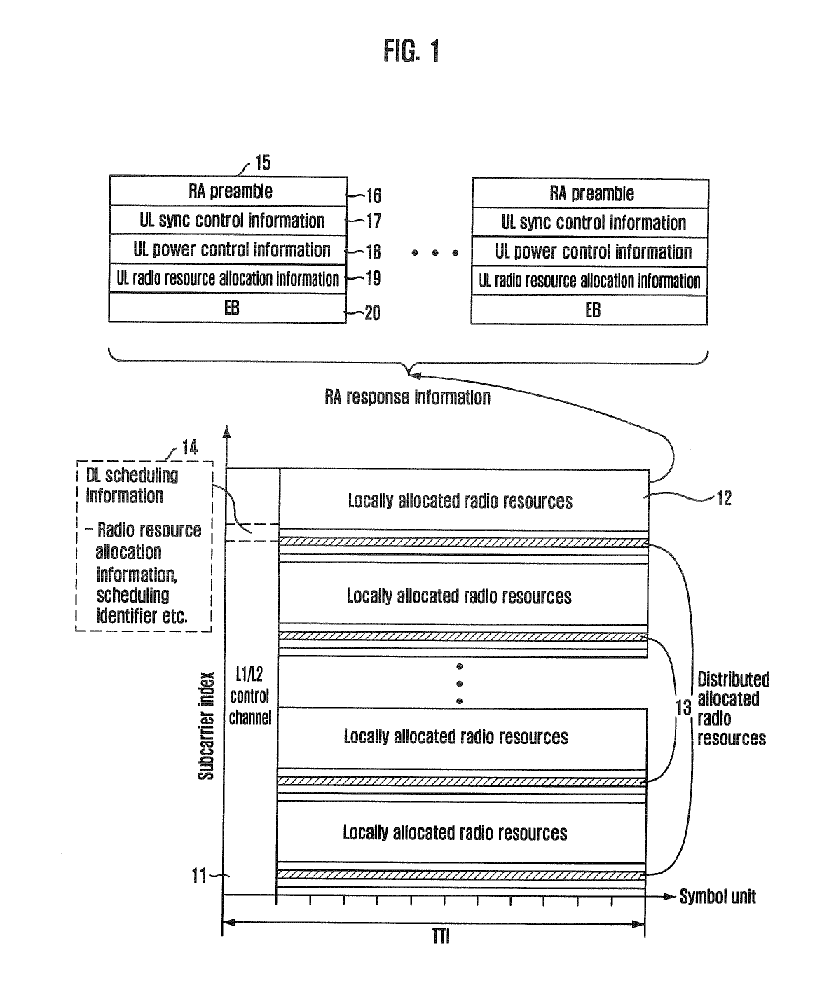

FIG. 1 exemplarily illustrates an architecture of response information when a response message to a non-contention-based random access is transmitted using a group scheduling identifier in accordance with an embodiment of the present invention.

Referring to FIG. 1, downlink scheduling information 14 is transmitted through a first layer (L1)/second layer (L2) control channel 11, and random access response information 15 is transmitted through radio resource blocks 12 and 13.

In a packet-based mobile communication system, since mobile stations within the coverage of a base station share radio resources, a scheduler of the base station takes in charge of allocating radio resources used for transmitting packet data to mobile stations or mobile station groups. The scheduler of the base station allocates the radio resources for packet data transmission in consideration of a radio environment between the base station and a mobile station and the quality of service (QoS). The packet-based mobile communication system requires an additional channel to transmit radio resource allocation information or scheduling information. Therefore, it is required to form an L1/L2 control channel 11 (which will be referred to as a physical layer control channel), transmitted at a scheduling unit, e.g., a Transmission Time Interval (TTI). The scheduling information 14 transmitted through the physical layer control channel 11 is formed of downlink information and uplink information. The scheduling information 14 should include at least a mobile station identifier for scheduling, location information of allocated radio resource blocks, a modulation scheme, and coding scheme in order to address the allocated radio resources.

The mobile station identifier for scheduling is an identifier for a specific mobile station or a specific mobile station group in the scheduler of the base station, such as Cell Radio Network Temporary Identifier (C-RNTI). According to the present invention, some of the mobile station identifiers for scheduling may be reserved and managed as group identifiers for indication or paging informing generation of downlink information.

The location information of allocated radio resource blocks informs the location (or section) of OFDM(A) radio resources, which are identified by frequency domain and time domain. In other words, the location information of allocated radio resource blocks indicates the location of random access response information allocated to shared radio resources. The random access response information is variably allocated to locally allocated radio resources 11 or distributed allocated radio resources 13 according to the amount of information to be transmitted to the mobile stations and/or a radio channel environment. Herein, the local allocation of radio resources is a method of allocating information transmitted to a specific mobile station to continuous specific subcarrier indexes. The distributed allocation of radio resources is a method of distributed allocating control information transmitted to a specific mobile station to subcarrier indexes having a predetermined interval and transmitting the subcarrier indexes with the control information.

The modulation scheme is information indicating what type of modulation schemes is used among a plurality of modulation schemes used in the packet-based mobile communication system. The coding scheme is information indicating what type of coding schemes is used among a plurality of coding schemes used in the packet-based mobile communication system. A fixed modulation or coding scheme may be applied according to selected preamble indexes or selected random access radio resources in order to efficiently form scheduling information on a physical layer control channel informing transmission of random access response information. In short, the scheduling information for informing the transmission of random access response information transmitted through the physical layer control channel can be efficiently formed by dividing radio resources into preamble resources or preamble groups for different random access according to the radio channel environment and applying modulation and coding schemes designated according to a random access preamble resource or preamble group.

Meanwhile, the scheduling information may further include Multiple Input Multiple Output (MIMO) antenna control information needed to use MIMO antennas and thereby improve the performance of the system and information related to retransmission of packet data that are being transmitted over the allocated radio resources.

The random access response information 15 may include random access preamble index 16 transmitted from the mobile station, uplink sync control information 17, uplink power control information 18, uplink radio resources allocation information 19, and extension bit 20.

The random access preamble index 16 transmitted from the mobile station indicates a specific random access preamble to be used by the mobile station in a non-contention-based random access procedure. The uplink sync control information 17 is control information for acquiring uplink physical layer synchronization when a mobile station receives a response message to a random access attempt executed by the base station and transmits packet data or control information through uplink. The uplink power control information 18 is information for controlling uplink transmission power when the mobile station receives a response message to the random access attempt executed by the base station and transmits packet data or control information through uplink. The uplink radio resources allocation information 19 is scheduling information of uplink radio resources allocated to be used for the mobile station to transmit packet data or control information through uplink after the mobile station receives a response message to a random access attempt executed by the base station. The uplink radio resources allocation information 19 may include uplink radio resource allocation information and modulation or coding scheme to be applied when data are transmitted over the radio resources.

The extension bit 20 is information indicating whether response information IE exists continuously when the response information is formed on the basis of information element (IE). For example, when extension bit 20 is “1”, it signifies that there is another response information IE. When extension bit 20 is “0”, it signifies that there is no other response information IE.

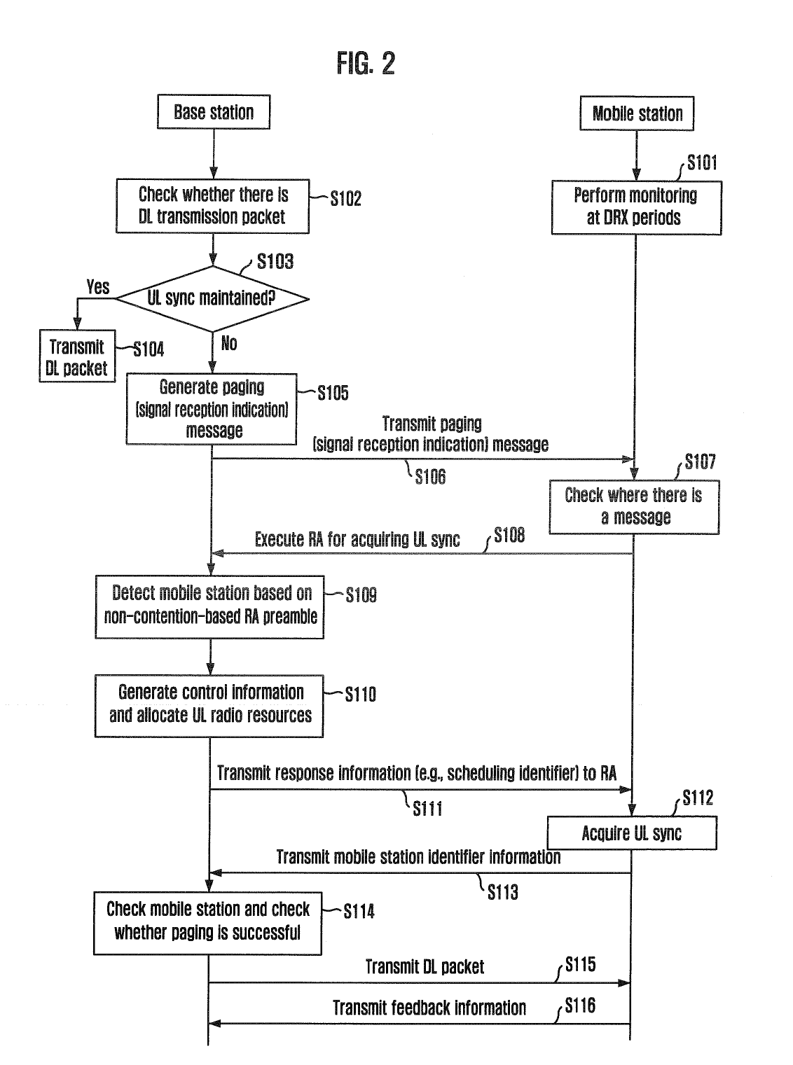

FIG. 2 is a flowchart describing a process of directing a mobile station to receive downlink packet data and transmitting downlink packet data, the mobile station maintaining Radio Resource Control (RRC) connection but not maintaining uplink synchronization in accordance with an embodiment of the present invention.

Referring to FIG. 2, mobile stations maintaining RRC connection for a packet service within the coverage of a base station performs operation at DRX periods to save power consumption based on the burst characteristic of packet data. In step S101, each mobile station monitors a physical layer control channel (or L1/L2 control channel) at every DRX period and checks scheduling information transmitted to it.

When downlink (DL) packet data to be transmitted to a certain mobile station are generated in step S102, the base station checks whether the mobile station maintains uplink (UL) physical layer synchronization before it transmits the downlink packet data to the mobile station in step S103.

If the mobile station maintains uplink physical layer synchronization, the base station transmits the downlink packet data in step S104. Otherwise, when the mobile station does not maintain the uplink physical layer synchronization, the base station informs the mobile station that there are downlink packet data to be transmitted to the mobile station and, at the same time, it generates an MAC paging message, directing the mobile station to execute a process for acquiring uplink synchronization in step S105. The MAC paging message is called downlink signal reception indication message.

In step S106, the base station transmits the MAC paging information (or an MAC control information message informing generation of downlink data), which is the downlink signal reception indication message, at the DRX period of the mobile station. The process of generating and transmitting a downlink signal reception indication message, which indicates a mobile station to receive downlink data, in order to transmit packet data or a control message from a base station to mobile stations not maintaining uplink physical layer synchronization in the RRC_CONNECTED state through downlink is similar to a paging procedure of a conventional system. The process can be defined as n MAC paging procedure for MAC to perform triggering.

The downlink signal reception indication message transmitted from the base station, which will be referred to as an MAC paging message hereinafter, may include a random access preamble index. The random access preamble index is valid only for the corresponding mobile station so that the mobile station could avoid colliding to (or contending with) other mobile stations in a random access procedure for acquiring uplink synchronization. In other words, the random access preamble index that the base station transmits to the mobile station through the MAC paging message is allocated only to the mobile station during a predetermined period (for example, in a section where several random access radio resources exist or a section of several radio frames). Accordingly, the mobile station can execute the random access procedure without colliding to (or contending with) other mobile stations. Herein, the valid section information for the transmitted random access preamble index may be transmitted being included in the MAC paging message, or it may be controlled to be recognized in advance by the mobile stations as random access information within system information, which is broadcasted by each base station.

The base station sets up an MAC paging parameter for MAC paging at a moment when it generates the MAC paging message. The MAC paging parameter may include a non-contention-based random access preamble index, non-contention-based random access preamble valid section timer information for MAC paging response, or contention-based random access section timer information for MAC paging response.

The non-contention-based random access preamble index is a preamble index allocated to a certain mobile station to be used by the mobile station in the non-contention-based random access procedure for acquiring uplink synchronization in response to the received MAC paging message after the mobile station receives an MAC paging message.

The non-contention-based random access preamble valid section timer information for MAC paging response is a timer value designating a section where a preamble index is valid. The base station allocates the preamble index to a certain mobile station so that the mobile station could execute a non-contention-based random access procedure. The non-contention-based random access preamble valid section timer information for MAC paging response may be defined as a section where there are several random access radio resources or a section of several radio frames.

The contention-based random access section timer information for MAC paging response is a timer value designating a section where a response to an MAC paging message through a contention-based random access procedure, when the mobile station does not normally complete the non-contention-based random access process executed by the mobile station upon reception of an MAC paging message within a non-contention-based random access preamble valid section timer vale, which is for responding to the MAC paging. The contention-based random access section timer information for MAC paging response is set as a multiple of the number of radio frames.

In step S107, a mobile station receives an MAC paging message transmitted to the mobile station by searching a control channel at discontinuous reception (DRX) periods. In step S108, upon receipt of an MAC paging message, the mobile station executes a non-contention-based random access procedure for acquiring uplink synchronization using a preamble designated by a random access preamble index included in the MAC paging message.

In step S109, the base station receives from the mobile station the preamble signal, which is a random access signal, for acquiring synchronization within a section where a non-contention-based random access preamble valid section timer for MAC paging response appears, and detects the mobile station based on the random access preamble index transmitted from the mobile station. In step S110, the base station generates control information such as uplink synchronization control information for the mobile station and/or uplink power control information, and allocates uplink radio resources to form response information to random access. Subsequently, the base station transmits downlink scheduling information including radio resource allocation information, over which random access response information is transmitted, through a control channel by using a scheduling identifier for a specific group or an object (e.g., Group-RNTI), illustrated in FIG. 1, in order to transmit the response information to random access in step S111. This way, the base station transmits the random access response information through a downlink shared channel (DL-SCH) designated by the scheduling information. The random access response message transmitted through the downlink shared channel is the same as described with reference to FIG. 1.

In the random access procedure for acquiring uplink synchronization, the mobile station may transmit a random access preamble allocated through the non-contention-based random access procedure to the base station until the non-contention-based random access preamble valid section timer for MAC paging response expires. However, when the mobile station does not receive random access response information from the base station until the non-contention-based random access preamble valid section timer for MAC paging response expires, the mobile station decides that the random access preamble index allocated by the base station is no more valid and attempts a response procedure for MAC paging through a contention-based random access method. Herein, the contention-based random access method is a conventional random access procedure in which a plurality of mobile stations transmit preamble signals for random access.

Also, as described above, when a mobile station transmits a preamble through a non-contention-based random access process upon MAC paging of the base station and receives random access response information from the base station in response to the preamble, the mobile station transmits mobile station identifier information to the base station by using uplink allocation resources within the random access response message. When the mobile station does not detect downlink scheduling information including its own mobile station identifier in a downlink physical layer control channel for a predetermined time (e.g., time when an arbitrary timer or a counter value ends), it recognizes that the random access procedure is failed and attempts the random access procedure again.

After receiving the response information transmitted from the base station through a non-contention-based random access procedure for acquiring uplink synchronization, the mobile station checks a response information block transmitted thereto through the random access preamble index within the response message, acquires uplink synchronization control information and/or uplink power control information, and establishes uplink synchronization by performing control based on the acquired uplink power control information in step S112. In step S113, the mobile station transmits the mobile station identifier information (e.g., C-RNTI) for identifying the mobile station itself to the base station by using the uplink radio resources allocated through random access response information.

The base station checks whether the mobile station is one that has executed MAC paging upon generation of uplink packet data based on the mobile station identifier information transmitted from the mobile station. During the procedure, when the mobile station identifier transmitted from the mobile station does not coincide with the mobile station identifier of a mobile station which is a target for the MAC paging attempted by the base station, the base station decides that the MAC paging is failed and then checks the MAC paging parameter to thereby execute the MAC paging procedure again or decide whether to execute RRC paging in step S114. Also, the base station may notify a mobile station which has transmitted a mobile station identifier not matched of an MAC paging error by using a corresponding scheduling identifier.

When the mobile station identifier transmitted from the mobile station coincides with the mobile station identifier of a mobile station which is a target for the MAC paging attempted by the base station, the base station forms downlink scheduling information for transmitting downlink packet data based on the mobile station identifier of a corresponding mobile station and transmits a packet data block by using the allocated downlink radio resources in step S115.

After acquiring uplink synchronization, the mobile station finds out that there is scheduling information including its scheduling identifier and receives a packet data block transmitted from the base station through the downlink radio resources figured out from the scheduling information. In step S116, the mobile station generates feedback information for making an HARQ response to the received packet data block, which is ACK or NACK, and transmits it to the base station through an uplink channel.

Meanwhile, when a mobile station does not receive a random access response message until a non-contention-based random access preamble valid section timer for MAC paging response expires and thus attempts MAC paging response procedure through a contention-based random access, it establishes synchronization according to a general contention-based random access procedure, and transmits mobile station identifier information (e.g., C-RNTI and S-TMSI) through an uplink shared channel after the synchronization is established. Subsequently, the base station performs the process of the step S114, where it checks the mobile station is a target mobile station for MAC paging based on the mobile station identifier information transmitted through an uplink shard channel.

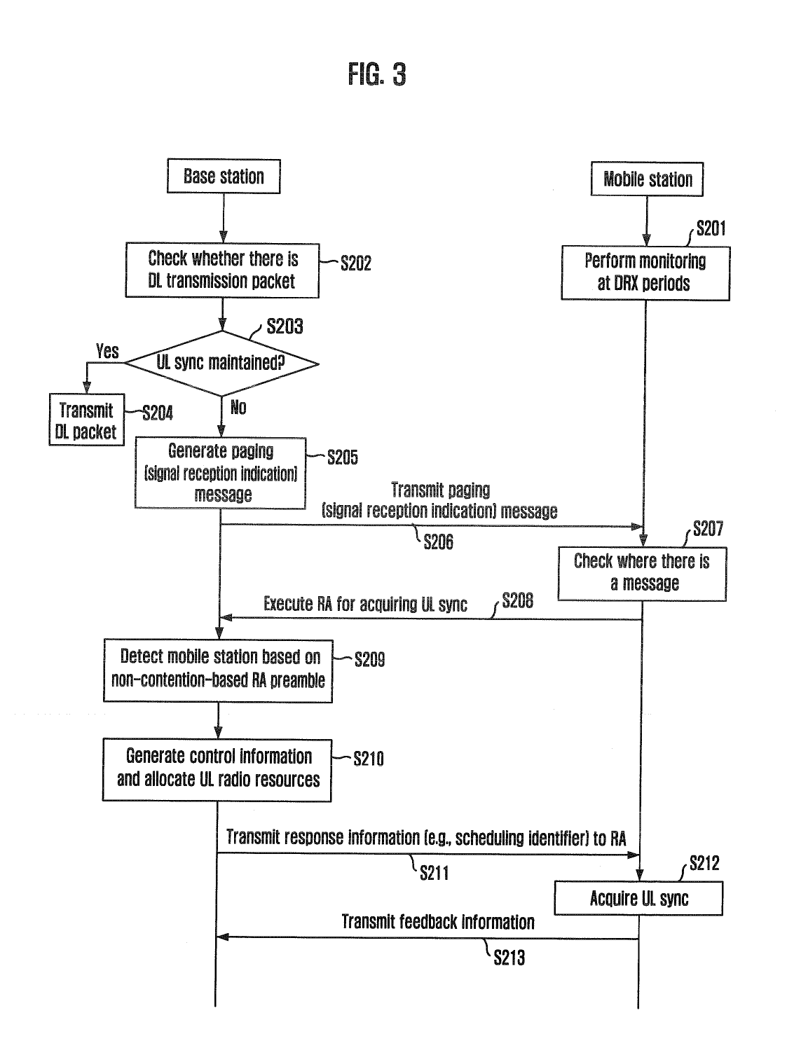

FIG. 3 is a flowchart describing a process of performing MAC paging onto a mobile station with RRC connection but without uplink synchronization and transmitting downlink packet data in accordance with another embodiment of the present invention.

This embodiment is different from the previous embodiment described with reference to FIG. 2 in that response information to random access is transmitted using scheduling information including a mobile station scheduling identifier unique to a mobile station. In other words, the base station transmits response information to random access by using scheduling information including a group scheduling identifier in the embodiment of FIG. 2. However, the base station transmits response information to random access by using scheduling information including a mobile station scheduling identifier unique to a mobile station in the embodiment of FIG. 3.

Referring to FIG. 3, when packet data are generated to be transmitted to a mobile station without maintaining uplink physical layer synchronization, a paging message is created and transmitted to the mobile station in steps S201 to 206. This is the same as the embodiment described with reference to FIG. 2.

Subsequently, when the base station receives a random access preamble signal for synchronization acquisition from a mobile station within a section where the non-contention-based random access preamble valid section timer appears, in step S209, it checks a scheduling identifier (e.g., C-RNTI) uniquely allocated to the mobile station based on a received random access preamble index for non-contention-based random access. In step S210, the base station generates control information such as uplink synchronization control information for the mobile station and/or uplink power control information and allocates uplink radio resource blocks to thereby form response information to random access.

The base station forms downlink scheduling information for random access response information based on the scheduling identifier, which is uniquely allocated to the mobile station and transmits the random access response information to the mobile station through a downlink shared channel in step S211. Herein, the base station may transmit downlink packet data along with the random access response information through the allocated radio resources. According to another method, the base station may allocate downlink radio resources after it transmits the random access response information to the mobile station and transmit packet data to the mobile station.

In step S212, the mobile station checks the random access response information transmitted through corresponding downlink radio resources by checking the scheduling information formed based on its own scheduling identifier, and establishes synchronization based on the uplink synchronization control information and/or uplink power control information. In step S213, the mobile station receives downlink packet data block transmitted from the base station through the downlink radio resources checked out from the scheduling information, generates feedback information for HARQ response, and transmits the feedback information to the base station through an uplink feedback channel.

Meanwhile, when the mobile station does not receive response information to random access until the non-contention-based random access preamble valid section timer for MAC paging response expires, it attempts to make a response to MAC paging through contention-based random access. The procedure is the same as described with reference to FIG. 2. When the random access is performed in the contention-based method, it is impossible for the base station to check whether a mobile station is a target mobile station for MAC paging based on the random access preamble index for non-contention-based random access. Therefore, the base station checks whether a mobile station is a target mobile station for MAC paging based on a mobile station identifier (e.g., C-RNTI and S-TMSI) transmitted from the mobile station through an uplink shared channel according to a general contention-based random access procedure.

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media.

While the present invention has been described with respect to the specific embodiments, it will be apparent to those skilled in the art that various changes and modifications may be made without departing from the spirit and scope of the invention as defined in the following claims.

### ADVANTAGEOUS EFFECTS

According to the present invention, when a mobile station with Radio Resource Control (RRC) connection operates at discontinuous reception (DRX) periods to save power consumption in a packet-based mobile communication system and the mobile station does not maintain uplink synchronization, a random access preamble index that is valid for a specific mobile station is allocated, inserted to a paging message, and transmitted. The method of the present invention can control uplink synchronization by having a mobile station execute random access in a non-contention-based method. Also, when the downlink signal reception indication is failed, it is possible for a base station to attempt the downlink signal reception indication again or to supplementary perform RRC paging.

### INDUSTRIAL APPLICABILITY

The present invention provides a downlink signal reception indicating method that can indicate a mobile station operating according to a discontinuous reception (DRX) period to save power consumption during Radio Resource Control (RRC) to receive downlink signals and effectively control uplink synchronization in a packet-based mobile communication system, when the mobile station is not maintaining uplink synchronization.

What is claimed is:

1. A method for indicating a mobile station maintaining radio resource control (RRC) connection but not maintaining uplink physical layer synchronization to receive downlink signals when packet data to be transmitted to the mobile station are generated to thereby make the mobile station start uplink signal transmission, comprising:
(a) allocating a random access preamble index and generating a downlink signal reception indication message including the allocated random access preamble index in a base station;
(b) transmitting the generated downlink signal reception indication message to the mobile station;
(c) forming a response message to random access, when a preamble signal designated by the random access preamble index is transmitted from the mobile station in response to the downlink signal reception indication message; and
(d) transmitting the response message to random access to the mobile station to thereby control uplink physical layer synchronization.
